(19) United States
(12) Patent Application Publication
(10) Pub. No.: US 2018/0199596 A1
(43) Pub. Date: Jul. 19, 2018

(54) PECTINS IMPROVING ENERGY REDISTRIBUTION IN ANIMALS

(71) Applicants: NUTRITION SCIENCES N.V., Drongen (BE); ROYAL AGRIFIRM GROUP B.V., Apeldoorn (NL)

(72) Inventors: Geert Bruggeman, Brugge (BE); Erik Bruininx, Apeldoorn (NL); Marco Van Den Berg, Delft (NL); Paulus De Vos, Groningen (NL); Neha Mohan Sahasrabudhe, Groningen (NL); Antonius Johannes Willibrordus Scheurink, Groningen (NL); Hendrik Arie Schols, Wageningen (NL); Jan Scholte, Peize (NL); Lingmin Tian, Wageningen (NL)

(21) Appl. No.: 15/743,455

(22) PCT Filed: Jul. 8, 2016
(86) PCT No.: PCT/EP2016/066354

§ 371 Date: Jan. 10, 2018

(30) Foreign Application Priority Data
Jul. 10, 2015 (EP) 15176281.2

(51) Int. Cl. A23K 20/163; A23K 50/30; A23K 50/40; A23K 50/50; A23K 50/60; A23L 29/231; A23L 33/105

(52) U.S. Cl. CPC A23K 20/163; A23K 50/30; A23K 50/40; A23K 50/50; A23V 2250/50724; A23L 29/231; A23L 33/105; A23V 2002/00; A23V 2200/332; A23K 50/60

(57) ABSTRACT

A composition includes a carbohydrate, which is pectin with an esterification degree less than 65%. A feed can include the composition. The composition or feed can be used for improving the feed intake pattern in animals and non-human animals or for improving the leanness of meat and other derived animal products.

### TECHNICAL FIELD

This invention relates to energy redistribution in animals by pectins with a specific degree of esterification. This energy redistribution is explained by a modified feed intake pattern due to the presence of pectins with a specific degree of esterification in the feed. This feed intake pattern is characterised by first latency to feed intake (delayed first meal), smaller meals, but more frequent meals. As a result, the total feed intake in the animal life is not affected, only the feed intake pattern is improved.

### BACKGROUND OF THE INVENTION

Improvement of feed efficiency towards lean meat is mandatory to ensure the worldwide demand for healthy animal derived food, such as meat. To achieve that goal the world is depending upon new technologies in intensive animal food production. In this context, the production rate in animals and more particularly lean meat quality is becoming increasingly important for animal (and subsequently human) health. In addition, the rising incidence of obesity among populations in industrialized areas has fueled the demand for a different feeding pattern (behavior as well as type of food products, such as meat with a lower fat content). This way, using functional carbohydrates to influence feeding behavior and/or fat deposition in livestock animals and—both indirectly and directly—in humans, will be an important tool to tackle the obesity problems in the human population.

Carbohydrates have been shown to be an essential feed ingredient in regulation hunger and satiety. The current invention aimed to identify specific carbohydrates, which are regulating satiety processes and have at the same time beneficial effects on the energy balance of animals, as an important health parameter. This target will become increasingly more important in animal health care.

### SUMMARY OF THE INVENTION

The current invention aims to provide a composition useful to be used as feed supplement, which provides an improved intake pattern, thereby resulting in a repartitioning of energy. The current invention thereto provides a composition according to claim 1 and use of such composition according to claim 7 or 12.

### FIGURES

FIG. 1 shows parts of the structure of pectin as well as (partially) esterified pectin.

### DESCRIPTION OF INVENTION

Pectins are found in the primary cell wall and middle lamella of the plant tissues as complex polymers of α-D-(1→4) galacturonic acid (McCready, 1970). They contribute to many functions in plants, affecting cell size and shape, tissue resistance, ion transport, water holding capacity, defence against pathogens and wounding (Voragen et al., 2001). At various stages of maturity of the plant the pectins are partially in the methyl ester form and may contain some acetyl groups (Jeraci and Lewis, 1989). However, in most research today, pectins are not further characterized, and observed effects cannot be attributed to a specific (sub)structure of pectins. Although it is expected that different pectic fractions can markedly affect the chemico-physical and the biological properties of the dietary fibre (Voragen et al., 2001; Bailoni et al. 2005), most research on nutritional effects of pectins lack structural research and therefore pectins are referred rather to antinutritional nutrients in feed, lowering overall feed intake resulting in lower animal performance.

Pectins are produced commercially as a white to light brown powder, mainly extracted from citrus fruits, and is used in food mainly as a gelling agent, particularly in jams and jellies. It is also used in fillings, medicines, sweets, as a stabilizer in fruit juices and milk drinks, and as a source of dietary fiber.

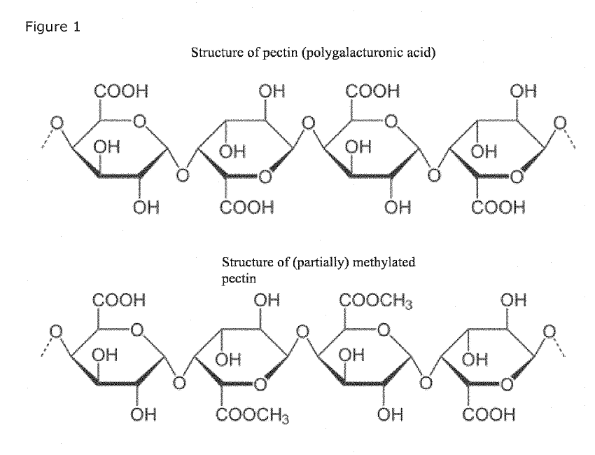

FIG. 1 shows parts of the structure of pectin as well as (partially) esterified pectin. The formula shows that the esterification is a methoxylation, but also other alkyl groups can be used (such as acetyl). It is clear that a pectin can be esterified with one group only (such as CH3 or COCH3) or with more than one group in the same structure. Preferably the esterification type of the pectin is either methylation and/or acetylation, more preferably methylation.

As seen in FIG. 1, pectin is a complex polysaccharide composed of a α-1,4-linked D-galacturonic acid (GalA) backbone (the so-called homogalacturonan or smooth region) and segments consisting of alternating sequences of α-(1,2)-linked L-rhamnosyl and α-1,4-linked D-galacturonosyl residues ramified with side chains of arabinans, arabinogalactans and galactans (branched rhamnogalacturonans or hairy regions). Pectins are decorated with neutral sugars (NS), mainly being galactose, arabinose and rhamnose.

Commercial pectins usually contain low amounts of neutral sugar as a result of the acid extraction (the neutral sugar content is around 5%). Other structural elements of pectins are xylogalacturonan and rhamnogalacturonan II. Rhamnogalacturonan II is carrying peculiar sugar residues such as Api (D-apiose), AceA (3-C-carboxy-5-deoxy-L-xylose), Dha (2-keto-3-deoxy-D-lyxo-heptulosaric acid) and Kdo (2-keto-3-deoxy-D-manno-octulosonic acid). The relative proportions of these different structural elements may vary significantly for different plant origins and the various derived commercial products.

The various substituents of pectin can be esterified. The major types of esterification are: O-methyl, O-acetyl and O-feruloyl. Not excluding any other types of esterification. Most of the esterifications reside in the homogalacturonan region on the GalA residues. The GalA residues can be thus present as free carboxyl groups or as esterified. Esterification can occur as mono-esterification, but also as double or even a triple esterification of single residues. The esterification on a single residue can be through a single type of alkyl group (i.e. methyl or acetyl), but is can also be a mixed type. Thus, GalA can also be acetylated (for example on the C-2 and/or C-3 position), which occurs as such in sugar beet and potato tuber pectins.

The degree of esterification (DE) is by definition the amount of esters (in moles) present per 100 moles of total galacturonic acids (free GalA and substituted GalA summed together). As most commercial pectins are essentially having esterifications of the methyl-ester type, the DE is often expressed as the degree of methylation (DM).

In that case, the degree of esterification is by definition the amount of methyl-esters (in moles) present per 100 moles of total galacturonic acids (free GalA and substituted GalA summed together). In the case that the esterification is of the acetyl type, the DE is often expressed as the degree of acetylation (i.e. DA). In that case, the degree of esterification is by definition the amount of acetyl-esters (in moles) present per 100 moles of total galacturonic acids (free GalA and substituted GalA summed together). In the case of multiple types of esterification, the DE is often expressed split in a degree of methylation (i.e. DM) and a degree of acetylation (i.e. DA). These are calculated as described above. Alternatively, the DE can be expressed as the degree of esterification, defined the by amount of galacturonic acid residues modified with one or more esterifications (in moles) present per 100 moles of total galacturonic acids (free GalA and substituted GalA summed together).

Commercial pectins can be a mixture of several populations: the distribution of the substituents can differ in an intramolecular level (within one single pectin polymeric chain) or in an intermolecular level (within one single pectin sample). This holds for all substituents, thus the sugars as well as the esterifications, and therefore both categories are meant with the word ‘substituents’ in the following. The substituents can be distributed completely at random. This random distribution can follow an even distribution pattern, when the substituents are regularly distributed over a single pectin polymeric chain, leading to a more homogenous pectin polymeric chain. If all pectin polymeric chains in a single pectin sample are of the same homogenous type, also the sample can be called homogeneous.

However, a single homogenous pectin polymeric chain can be present in a composition with other homogenous pectin polymeric chains but having a different intramolecular (but still homogeneous) distribution of the substituents. In this case, the pectin sample should be considered heterogeneous.

This invention describes the surprising observation that supplying pectins with a specific range of esterification to animals and rats, the objects consume same amounts of feed but by an improved intake pattern, characterised by first latency to feed intake (delayed first meal), smaller meals, but more frequent meals. This intake pattern lowers glucose and insulin levels in the blood and slows down gastric emptying. This finally results in a repartition of energy (fat tissue) improving the lean tissue composition. This mode of action of specific pectins is novel and not earlier described for animal and even human nutrition.

The degree of esterification in the context of the present invention is preferably determined by the HPLC method as described by Voragen at al. (2001), in the publication titled “Determination of the degree of methylation and acetylation of pectins by h.p.l.c,”, published in Food Hydrocolloids vol. I no. I pp. 65-70. 1986.

The term “animal” means an animal likely to develop or suffering energetic unbalances, including avian, bovine, canine, equine, galline, feline, hircine, lapine, murine, musteline, ovine, piscine, porcine and vulpine animals. Preferably, the animal is a porcine, galline, bovine, ovine, canine, feline.

In a first aspect, the current invention provides a composition comprising a carbohydrate, whereby said carbohydrate is pectin with a esterification degree less than 65%, or derivatives thereof.

Preferably the esterification type of the pectin according to the current invention is either methylation and/or acetylation, more preferably methylation.

Said derivatives may include salts (pectinates or pectates) such as Ca2+, Na+ or K+ salts, modified citrus pectin (MCP) or amidated pectin whereby said at least part of the galacturonic acid is converted with ammonia to carboxylic acid amide, substitution (alkylation, amidation, quaternization, thiolation, sulfation, oxidation, etc.), chain elongation (cross-linking and grafting) and depolymerization (chemical, physical and enzymatic degradation). The presence of an amide group is typically at the C-6 position of the amidated GalA residues. However this does not exclude amide groups being present on of any of the other positions. If pectin is amidated, the DE is often expressed as the degree of amidation (i.e. DAM). In that case, the degree of esterification is by definition the amount of amides (in moles) present per 100 moles of total galacturonic acids (free GalA and substituted GalA summed together).

The following distinction is made among the esterified pectins:

(i) Low-esterified pectins (LEP)
(ii) High-esterified pectins (HEP).

Low-esterified pectins have a degree of esterification (DE) of less than 50%. This means that less than 50% of the possible positions are esterified.

High-esterified pectins have a DE of more than 50%. This means that more than 50% of the possible positions are esterified.

In a further embodiment, said degree of esterification is less than 65%, more preferably less than 60%, more preferably less than 55%, more preferably less than 50%, more preferably less than 45, more preferably less than 40%, 35%, 30%. By preference, said pectin is a low-esterified pectin (LEP).

Usually the pectin has a DE of at least 1%, preferably of at least 2, more preferably of at least 3%. Therefore there is a range of 1-65%, 2-65%, 3-65%, 1-60%, 2-60%, 3-60%, 1-55%, 2-55% and 3-55%.

In another embodiment, said degree of esterification is between 0 and 65%, more preferably between 5 and 60%, more preferably between 5 and 55%, more preferably between 5 and 50%.

By preference, said pectin comprises one or more polymers of α-D-(1→4) galacturonic acid or mixtures of one or more of said polymers.

It was surprisingly found that the composition as described above has a positive effect on the energy redistribution in animals. This energy redistribution is explained by a modified feed intake pattern which on its turn is characterised by first latency to feed intake (delayed first meal), smaller meals, but more frequent meals. As a result, the total feed intake in the human or animal life is not affected, only the feed intake pattern is improved. Pectins with a specific degree of esterification according to the current invention act as specific carbohydrates on the mechanism of nutrient absorption in the intestinal tract of animals and humans.

The source of these pectins is not essential for the observed effect. In the context of the present the pectins can be obtained from any known sources. Pears, apples, guavas, quince, plums, gooseberries, oranges, and other citrus fruits contain large amounts of pectin, while soft fruits like cherries, grapes, and strawberries contain small amounts of pectin. Also other plant sources than fruits can comprise pectin. For example, pectin can be sourced from potato, soy, sugar beet, chicory, carrot, tomato, pea, parsnip, and (green) beans.

As mentioned, pectins are present in almost all higher plants. Several by-products of the food industries are used for their extraction, such as citrus peels (by-product of lemon juice production), apple pommace (by-product of apple juice manufacture), sugar beet (by-product of the beet-sugar industry) and in a minor extend potatoes fibres, sunflower heads (by-product of oil production) and onions. Note that this list is not exhaustive. The methods for obtaining pectins with specific degree of esterification are well known in the art.

The composition according to the current invention may further comprise additional raw materials (additives) and/or growth-promoting substances. The additives are, in a preferred embodiment, selected from the group consisting of aroma's and plant extracts. In a further preferred embodiment, the growth-promoting components are selected from the group, consisting of antibiotics, vitamins, trace elements, probiotics, prebiotics, essential oils, enzymes, fatty acids, and (in)organic acids. Non-limiting examples of organic acids which can be used in an embodiment of the invention, comprise C1-C12 carboxylic acids, in particular unsubstituted carboxylic acids such as formic acid, acetic acid, propionic acid, butyric acid, valeric acid, medium chain fatty acids; and/or substituted carboxylic acids such as adipic acid, maleic acid, succinic acid, citric acid, fumaric acid, tartaric acid, lactic acid, gluconic acid, succinic acid and ascorbic acid, including cyclic carboxylic acids such as picolinic acid. The organic acids may contain one or more substituted or unsubstituted carboxylic acids, as well as mixtures thereof, as well as saturated, unsaturated, cyclic, and/or aliphatic carboxylic acids or mixtures thereof, as well as metal complexes and/or salts thereof, as well as racemic and/or enantiomeric forms thereof. Non-limiting examples of inorganic acids which can be used in an embodiment of the invention include strong acids in small amounts, such as perchloric acid (hydroperchloric acid), hydrogen iodide, hydrogen bromide (hydrobromic acid), hydrogen chloride (hydrochloric acid), sulfuric acid and nitric acid; as well as weak inorganic acids such as phosphoric acid, hydrofluoric acid, hypochlorous acid, and nitrous acid.

In one embodiment, the pectins in the composition according to the invention are present in liquid or solid form. In a further embodiment, the composition according to the invention as described herein is formulated as a liquid or a solid form. The term “solid form” means a powder in particular. The term “liquid form”, in particular, means a solution in water or means a solution in oil. In particular, the composition is suitable for oral administration.

The composition according to the current invention is typically useful to be used as food or feed supplement. In one embodiment, the concentration of the pectin, as described herein, amounts at least 1, 5, 10, 15, 20, 25, 30, 35, 40, 45, 50, 55, 60, 65, 70, 75, 80, 85, 90, 95, 99, 100% by weight of the composition. In a further embodiment, the pectin, as described herein, amounts to (based on dry weight) between 1 g/100 g composition (1% by weight) and 100 g/100 g composition (100% by weight), preferably between 50 g/100 g and 90 g/100 g composition (50-90% by weight), more preferably between 60 g/100 g and 80 g/100 g.

The composition according to the current invention is typically relates to an animal feed comprising the composition as mentioned above. By preference, said composition is present in 0.01 to 10 wt % of the total amount of weight of said composition. In another embodiment, said pectins with a DE according to the current invention (as described above) are present in an amount of 0.01 to 5 wt % based on the total weight of the feed formulation.

In particular, the composition or feed as described in one or more of the embodiments above, are used for improving the feed intake pattern of animals, thereby redistributing the energy in animals. Such use is characterised by latency to feed intake (delayed first meal), smaller but more frequent meals. For the purpose of the current invention, the term ‘energy’ is to be understood as representing the fat tissue present in animals.

By using the composition or feed according to the current invention, less fat is deposited in the visceral tissue of the animal, improving the leanness of meat and other derived animal products such as eggs and/or milk.

Conclusive, the use of pectins with a degree of esterification less than 65% contribute to a redistribution of energy in the body of the animal, by showing first latency to feed intake (delayed first meal), and consuming subsequently smaller meals, but at a more frequent rate. In order that the present invention may be more clearly understood, the preferred form will be described with reference to the following examples.

### Example 1: Incorporation of LM Pectin in Diets Leads to More and Smaller Meals

### Rat Feeding Trial Set-Up

17 Male Wistar rats (weight ±320 g; Harlan Netherlands BV, Horst, The Netherlands) were individually housed in TSE cages in a climate-controlled room (21C±1) under a 12 h:12 h light-dark cycle (lights on at 10:00 AM). These specialized cages were equipped with food weighing sensor for continuous registration of food intake for multiple days (TSE Systems GmbH, Bad Homburg, Germany) to monitor circadian feeding patterns, meal sizes and meal numbers. Circadian food intake patterns were calculated as an average of the last two consecutive days, the first day was used for adaptation. These plexiglass cages (40×23×15 cm) consist of a sensitive weight balanced food station (stainless steel food container for standard size food pellets).

Animals were maintained ad libitum on the diets. Water was available ad libitum throughout the study. Food intake and body weights were measured daily at 10 AM. For weighing a laboratory scale was used (sensitivity 0.1 gram). Experiments were approved by the Ethical Committee of Animal Experiments of the University of Groningen.

All animals were instrumented with chronic heart catheters bilaterally in the jugular vein allowing stress free blood sampling during an intravenous glucose tolerance test (IVGTT). Surgeries were carried out under general isoflurane (2%) anesthesia. Animals had at least 10 days to recover before the start of the experiments. Cannulas were checked every week for patency.

The full trial lasted 11 weeks:
week1: meal pattern measurements (TSE)
week3: Blood sampling during a single meal of 1.5 grams
week4: meal pattern measurements (TSE)
week6: Intravenous Glucose Tolerance Test
week9: meal pattern measurements (TSE)
week11: carcass analysis

### Diets

9 rats were fed with a control diet, while 8 rats were fed with pectin enriched diet. The composition of the diets was as follows: 95% chow RMH-B meal (obtained from Arie Blok, Woerden, the Netherlands) and 5% Pectin (see Pectin sources). The diets were prepared by mixing all components (including 0,25% TiO2 as marker) with water to 600 ml/kilo in an industrial mixer until a homogeneous mixture/dough was obtained. After 20 minutes of mixing, the diets were pelleted using a pelleting machine (diameter 1.0 cm). The obtained pellets were dried for 48 hours using compressed air at room temperature.

### Pectin Sources

Pectin with a DE 33 were isolated from citrus and obtained from Herbstreith & Fox (Neuenbürg/Württingen, Germany).

### Feeding Pattern Analyses

During the second meal pattern measurements the animals were observed and measurements were performed for 48 hours. The obtained data was averaged over all animals fed on a certain diet and is presented in the table below. Statistical analyses were performed using student T test.

| | Control diet | Pectin DE 33 diet |
|---|---|---|
| Number of meals | 20.56 ± 0.84 | 23.25 ± 0.82 |
| Average meal size (g) | 1.99 ± 0.07 | 1.75 ± 0.11 |
| Average meal duration (min) | 8.22 ± 0.54 | 9.22 ± 0.25 |
| Average eating speed | 0.32 ± 0.04 | 0.21 ± 0.01 |
| (g/min) | | |

Surprisingly, pectin fed animals consumed significantly more meals which are smaller in size. Still, the total amount eaten in the period for both diets is not significantly different (40.92 vs 40.69 grams).

### Example 2: Incorporation of LM Pectin in Diets Leads to Reduced Fat Deposition

The rat trial was as described in example 1. After sacrifice a carcass analysis was performed to determine the amount of fat. Liver, stomach, gut (ilium to rectum), spleen, kidneys were removed and weighed. Retroperitoneal and epididymis fat was weighed as well. The fat content from the skin, carcass and gut was determined using a petroleum based Soxlet fat extractor. Visceral fat here was defined as the total of intestinal fat, epididymal fat and retroperitoneal fat.

| | Control diet | | Pectin DE 33 diet | |
|---|---|---|---|---|
| | | Relative vs | | Relative vs |
| | Grams (or g/g | body weight | Grams (or g/g | body weight |
| | for the ratio) | (%) | for the ratio) | (%) |
| Total fat | 76.03 ± 3.26 | 19.5 | 67.74 ± 2.51 | 17.8 |
| Visceral fat | 21.66 ± 1.22 | 5.5 | 17.86 ± 1.21 | 4.7 |
| Gut fat | 4.46 ± 0.23 | 1.1 | 3.51 ± 0.31 | 0.9 |
| Ratio | 0.54 ± 0.03 | n.a | 0.45 ± 0.03 | n.a. |
| fat:lean | | | | |
| mass | | | | |

Surprisingly, pectin fed animals have a reduced absolute as well as relative percentage of fat. This is also visible for the amount and relative percentage of visceral and gut fat.

### Example 3: Effect of Low- and High Esterified Pectins on Overall Feed Intake in Piglets

### Context of the Example

Pectin with a DM value of 33% have been tested in young pigs and have shown to have beneficial effects on feed intake compared to DM>65.

During a 35-d experimental period 621 weaned piglets (7.4 kg bodyweight) were assigned to either 1) a control group 2) a diet containing 3% pectin 33% DM or 3) a diet containing 3% pectin >65% DM. Piglets were housed in weanling pig facilities in pens with 7-9 piglets per pen resulting in 27 pens (replicates) per treatment. Per treatment 4 of these replicates were housed in pens equipped with IVOG® feeding stations for weanling pigs to enable measurement of individual feed intake characteristics. Piglets were given ad libitum access to feed and water during the whole 35-d period.

| | Control | Pectin DE 33 | Pectin DE >65 | p-value |
|---|---|---|---|---|
| Feed intake | 455.58 a | 475.78 a | 407.13 b | <.001 |

Surprisingly, Low-esterified pectins (represented by pectin DE 33) maintain feed intake over the piglet growth time, while High-esterified pectins (represented by pectin DE>65) affects feed intake in a negative way.

### REFERENCES

JERACI, J. L. & LEWIS, B. A. (1989). Determination of soluble fibre components: (1->3; 1->4)-β-D-glucans and pectins. Anim. Feed Sci. Technol. 23:15-25.
BAILONI, L., SCHIAVON, S., PAGNIN, G., TAGLIAPIETRA, F. & BONSEMBIANTE, M. (2005). Quanti-qualitative evaluation of pectins in the dietary fibre of 24 foods, Ital. J. Anim. Sci. 4: 49-58.
MCCREADY, R. M. (1970). Pectin. In: JOSLYN, M. A. (ed.) Methods in food analysis: physical, chemical and instrumental method of analysis. Academic Press, New York, USA, 565-595.
VORAGEN, A. G. J., BELDMAN, G. & SCHOLS, H. (2001). Chemistry and Enzymology of Pectins. In: MCCLEARY, R. M. & PROSKY, L. (eds.) Advanced dietary fibre technology. Blackwell Sci. Ltd., Oxford, UK, 379-398.

1. A composition comprising a carbohydrate, whereby said carbohydrate comprises at least one pectin with an esterification degree less than 65%.

2. The composition according to claim 1, characterized in that said pectin has a degree of esterification less than 55%.

3. The composition according to claim 1, wherein the said pectin comprises one or more polymers of α-D-(1→4) galacturonic acid or mixtures of one or more of said polymers.

4. The composition according to claim 1, wherein the said composition further comprises vitamins, trace elements, minerals or carboxylic acids and/or salts thereof, selected from the group of valeric acid, formic acid, acetic acid, propionic acid, medium chain fatty acids, lactic acid, butyric acid, citric acid, maleic acid, fumaric acid, benzoic acid, succinic acid, sorbic acid, tartaric acid.

5. The composition according to claim 1, wherein the said pectin is present in said composition in concentration of between 1 to 100% of total weight of said composition.

6. A feed comprising a composition according to claim 1 and additional nutritive components.

7. The feed according to claim 6, wherein the said composition is present in 0.01 to 10% of the total amount of weight of said composition.

8. The feed according to claim 6, comprising 0.01 to 5% wt pectins based on the total weight of the feed formulation.

9. A method for improving the feed intake pattern of a human or a non-human animal in order to repartition energy in the human or non-human animal, comprising feeding the human or non-human animal a composition according to claim 1.

10. The method according to claim 9, wherein the improved feed pattern comprises latency to feed intake (delayed first meal), and smaller but more frequent meals.

11. The method according to claim 9, wherein animals are belonging to the group of animals likely to develop or suffering from energetic unbalances, including avian, bovine, canine, equine, galline, feline, hircine, lapine, murine, musteline, ovine, piscine, porcine and vulpine animals.

12. The method according to claim 11, wherein animals are porcine, galline, bovine, ovine, canine, feline.

13. The method according to claim 9, wherein energy represents the fat tissue of the animal or human.

14. A method for improving the leanness of meat and other derived animal products from an animal, comprising feeding the animal a composition according to claim 1.

15. The method according to claim 14, wherein derived animal products are meat, eggs and milk.
